(19) United States
(12) Patent Application Publication
(10) Pub. No.: US 2004/0064495 A1
(43) Pub. Date: Apr. 1, 2004

(54) Polynomial inverse computing apparatus, multiplier apparatus and polynomial inverse computing method

(76) Inventors: Hideo Shimizu, Kawasaki-shi (JP); Atsushi Shimbo, Fuchu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/661,607

(22) Filed: Sep. 15, 2003

(30) Foreign Application Priority Data
Sep. 30, 2002 (JP) 2002-287860

(51) Int. Cl. G06F 7/38

(52) U.S. Cl. 708/502

(57) ABSTRACT

A polynomial inverse computing apparatus comprises first to sixth registers, a left shift unit, first and second exclusive-OR units, a doubling computing unit which executes doubling computation in an extension field with characteristic 2, a halving computing unit which executes halving computation in the extension field of characteristic 2, a determination unit which determines whether or not a content of each register is 0, a decrement unit which decrements the content of each register, an increment unit which increments the content of each register.

### CROSS-REFERENCE TO RELATED APPLICATIONS

This application is based upon and claims the benefit of priority from the prior Japanese Patent Application No. 2002-287860, filed Sep. 30, 2002, the entire contents of which are incorporated herein by reference.

### BACKGROUND OF THE INVENTION

1. Field of the Invention

The present invention relates to a polynomial inverse computing apparatus, multiplier apparatus and method for use in the Galois field with characteristic 2 suitable for VLSI (very large scale integration) mounting.

2. Description of the Related Art

The Galois field with characteristic 2 is applicable in various industrial fields, such as code theory systems, elliptic curve cryptosystems, etc. Computation of the inverse of each element in the Galois field with characteristic 2 is needed for addition of rational points on the elliptic curve of characteristic 2.

Extended Euclidean algorithm is known as an algorithm for computing the inverse of each element in an arbitrary field. However, since Extended Euclidean algorithm requires multiplication and division, if hardware dedicated to the algorithm is incorporated, the number of required operation steps and the circuit scale are inevitably increased.

In 1987, Stein proposed an improvement in Extended Euclidean algorithm that does not need multiplication and division. This improvement enables an apparatus for computing the inverse of each element in the Galois field with characteristic 2 to be formed of a shift operation circuit, exclusive-OR circuit, comparison circuit for comparing the highest orders of two polynomial equations, determination circuit for determining whether each polynomial equation assumes a constant value, and control circuit.

In general, the performance of VLSIs is determined on the basis of three factors, i.e., the number of execution cycles (i.e. latency), circuit scale and circuit delay. Assuming that the highest order of a modulo polynomial is m, the latency is 2 m steps in the Stein algorithm, and no quicker operation than this can be theoretically expected from the algorithm. Further, the circuit scale is O (m), and the circuit delay is O (log m). Among the above-mentioned circuits, the comparison circuit and determination circuit increase both the circuit scale and delay. If the Stein algorithm is used in elliptic curve cryptosystems, m is several hundred.

In addition to the above, various methods for increasing the speed of computing the inverse of each element in various Galois fields have been proposed by the following patent documents,

1. Jpn. Pat. Appln. KOKAI Publication No. 2000-047833,

2. Jpn. Pat. Appln. KOKAI Publication No. 2000-315201,

3. Jpn. Pat. Appln. KOKAI Publication No. 2000-322280,

4. Jpn. Pat. Appln. KOKAI Publication No. 2002-023999.

As described above, if a VLSI is employed which is dedicated to the Stein algorithm as a conventional algorithm for computing the inverse of each element in the Galois field with characteristic 2, the entire circuit scale and delay are inevitably increased.

### BRIEF SUMMARY OF THE INVENTION

The present invention has been developed in light of the above, and aims to provide a polynomial inverse computing apparatus and method capable of reducing the entire circuit scale and delay, compared to the prior art, if a VLSI is employed which is dedicated to an algorithm for computing the inverse of each element in the Galois field with characteristic 2.

The present invention also aims to provide a multiplier apparatus capable of commonly using most components of a polynomial inverse computing apparatus if the polynomial inverse computing apparatus is formed of a VLSI dedicated to a polynomial inverse computing algorithm for the Galois field with characteristic 2.

According to an aspect of the invention, there is provided a polynomial inverse computing apparatus comprising: a plurality of registers including a first register, a second register, a third register, a fourth register, a fifth register, and a sixth register; a left shift unit; a first exclusive-OR unit and a second exclusive-OR unit; a doubling computing unit configured to execute doubling computation in an extension field with characteristic 2; a halving computing unit configured to execute halving computation in the extension field of characteristic 2; a determination unit configured to determine whether or not a content of each of the registers is a zero value; a decrement unit configured to decrement the content of each of the registers; and an increment unit configured to increment the content of each of the registers.

According to a second aspect of the invention, there is provided a polynomial inverse computing apparatus comprising: a first register which stores a divisor as an initial value; a second register which stores a modulo as an initial value and holds a content of the first register in a first condition; a third register which stores a dividend as an initial value; a fourth register which stores a zero value as an initial value and holds a content of the third register in the first condition; a fifth register which stores a number of bits of the modulo as an initial value; a sixth register which stores the zero value as an initial value; a first exclusive-OR unit configured to obtain a first exclusive-OR result of contents of the first register and the second register and outputs the first exclusive-OR result to the first register in the first condition; a second exclusive-OR unit configured to obtain a second exclusive-OR result of contents of the third register and the fourth register and outputs the second exclusive-OR result to the third register in the first condition; a left shift unit configured to left-shift the content of the first register in a second condition; a doubling computing unit configured to execute doubling computation on the content of the third register in an extension field with characteristic 2 in the second condition; a first decrement unit configured to decrement a content of the fifth register in the second condition; a second decrement unit configured to decrement a content of the sixth register in the second condition; a halving computing unit configured to executes halving computation on a content of the fourth register in the extension field with characteristic 2 in a third condition; an increment unit configured to increment the content of the sixth register in the third condition; a first determination unit configured to determine, in a fourth condition, whether or not the content of the fifth register is the zero value; and a second determination unit configured to determine, in a fifth condition, whether or not the content of the sixth register is the zero value.

According to a third aspect of the invention, there is provided a multiplier apparatus comprising:

a plurality of registers including a first register, a second register, a third register, and a fourth register,

the first register, the second register, the third register, and the fourth register store a multiplier, a zero value, a multiplicand, and a modulo, respectively, the registers being used for a polynomial inverse computing apparatus;

a determination unit configured to determine whether or not a content of the fourth register is the zero value;

if the determination unit determines the content of the fourth register is a non-zero value,

a decrement unit configured to decrement the content of the fourth register;

a doubling computing unit configured to execute doubling computation in an extension field with characteristic 2 to the second register;

a left shift unit configured to left-shift the content of the first register;

if a most significant bit of the first register is 1,

a exclusive-OR unit configured to obtain a exclusive-OR result of contents of the second register and the third register and output the exclusive-OR result to the second register; and

an output unit configured to output a content of the second register if the determination unit determines the content of the fourth register is the zero value.

According to a fourth aspect of the invention, there is provided a polynomial inverse computing method comprising:

storing, as initial values into a first register, a second register, a third register, a fourth register, a fifth register, and a sixth register, a divisor, a modulo, a dividend, a zero value, a number of bits of the modulo and the zero value, respectively;

in a first state, unless a most significant bit of the first register is 1, repeatedly performing a first series of operations, the first series of operations including

left-shifting a content of the first register,

doubling a content of the third register,

decrementing a content of the fifth register by 1, and

incrementing a content of the sixth register by 1,

the first state being;

in a second state shifted from the first state if the most significant bit of the first register is 1,

storing an output of a first exclusive-OR unit which inputs contents of the first register and the second register, and the content of the first register into the first register and the second register, respectively, and

storing a second exclusive-OR unit which inputs contents of the third register and the fourth register, and the content of the third register into the third register and the fourth register, respectively,

in a third state shifted from the second state after the second state finishes, unless the content of the sixth register is the zero value, and as long as the most significant bit of the first register is 1, repeatedly performing a second series of operations, the second series of operations including

storing the output of the first exclusive-OR unit into the first register,

storing the output of the second exclusive-OR unit into the third register,

decrementing the content of the sixth register by 1, left-shifting the content of the first register, and

halving the content of the fourth register,

the third state being shifted to the first state if the content of the sixth register is the zero value and if the content of the fifth register is non-zero value,

the content of the fourth register being output as a result if the content of the sixth register is the zero value and if the content of the fifth register is the zero value.

### BRIEF DESCRIPTION OF THE SEVERAL VIEWS OF THE DRAWING

FIG. 1 is a flowchart illustrating an algorithm for computing the inverse of each element in an extension field with characteristic 2, according to an embodiment of the invention;

FIG. 2 is a view useful in explaining how a polynomial equation according to the embodiment is expressed;

FIG. 3 is a view useful in explaining “left_shift” performed in the embodiment;

FIG. 4 is a flowchart useful in explaining “doubling” performed in the embodiment;

FIG. 5 is a flowchart useful in explaining “halving” performed in the embodiment;

FIG. 6 is a table useful in explaining the polynomial inverse computing algorithm according to the embodiment;

FIG. 7 is a view illustrating an example of a hardware configuration for executing the polynomial inverse computing algorithm of the embodiment;

FIG. 8 is a view illustrating an example of a state transition diagram assumed by hardware for executing the polynomial inverse computing algorithm of the embodiment;

FIG. 9 is a view illustrating an example of a configuration of a multiplier that commonly uses most components of the hardware of FIG. 7;

FIG. 10 is a view illustrating an example of a one-hot counter employed in the embodiment; and

FIG. 11 is a flowchart illustrating another algorithm, according to the embodiment, for computing the reverse of each element in an extension field with characteristic 2.

### DETAILED DESCRIPTION OF THE INVENTION

An embodiment of the invention will be described with reference to the accompanying drawings.

An algorithm for computing the inverse of each element of polynomial A in an extension field of GF(2), G as a modulo, will now be described.

modulo G (G: an mth-order polynomial), m divisor a (a: a polynomial whose order is lower than m), and dividend b (b: a polynomial whose order is lower than m) are given as inputs.

The following initial values are set:

```
    A = a (A: an mth-order polynomial)
    B = b (B: an mth-order polynomial)
    C = G (C: an mth-order polynomial)
    D = 0 (D: an mth-order polynomial)
    n = 0 (n: an integer variable which can hold
integer less than or equal to m)
```

In this algorithm, output D is A⁻¹ B. Accordingly, when the inverse of each element of polynomial A is computed, the initial value of B, i.e., b, is set to 1. If only the inverse of each element is computed using the algorithm, the initial value of B may be set to 1 without using b as an input.

The algorithm will be described in detail. In the algorithm below, msb (A) represents the highest-order coefficient of A. Further, left_shift (A) represents a remainder obtained by multiplying polynomial A by X and dividing the resultant by X^{m}. The double (B) represents a remainder obtained by multiplying polynomial B by X and dividing the resultant by modulo polynomial G. The half (D) represents a remainder obtained by multiplying polynomial D by 1/X and dividing the resultant by modulo polynomial G.

```
  <Polynomial inverse computing algorithm 1>
  Input of G, m, a and b
  Initialization of A, B, C, D and n
while m ≠ 0
// step 1
while msb(A) = 0
  m [symbol] m−1;
  n [symbol] n+1;
  A [symbol] left_shift(A);
  B [symbol] double(B);
wend
// step 2
  (A, C) [symbol] (A xor C, A);
  (B, D) [symbol] (B xor D, B);
// step 3
while n ≠ 0
  if msb(A) = 1 then (A, B) [symbol] (A xor C, B xor D)
  n [symbol] n−1
  A [symbol] left_shift(A)
  D [symbol] half(D)
wend
wend
D is output
  <Polynomial inverse computing algorithm 1>
```

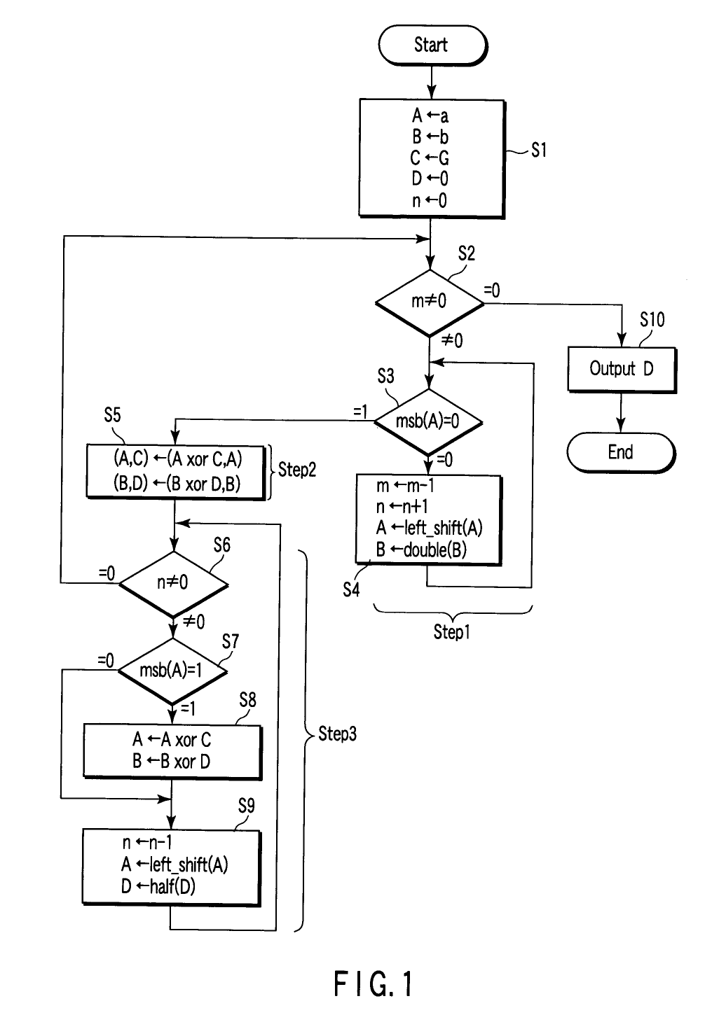

The contents of this algorithm are expressed in the form of a flowchart in FIG. 1.

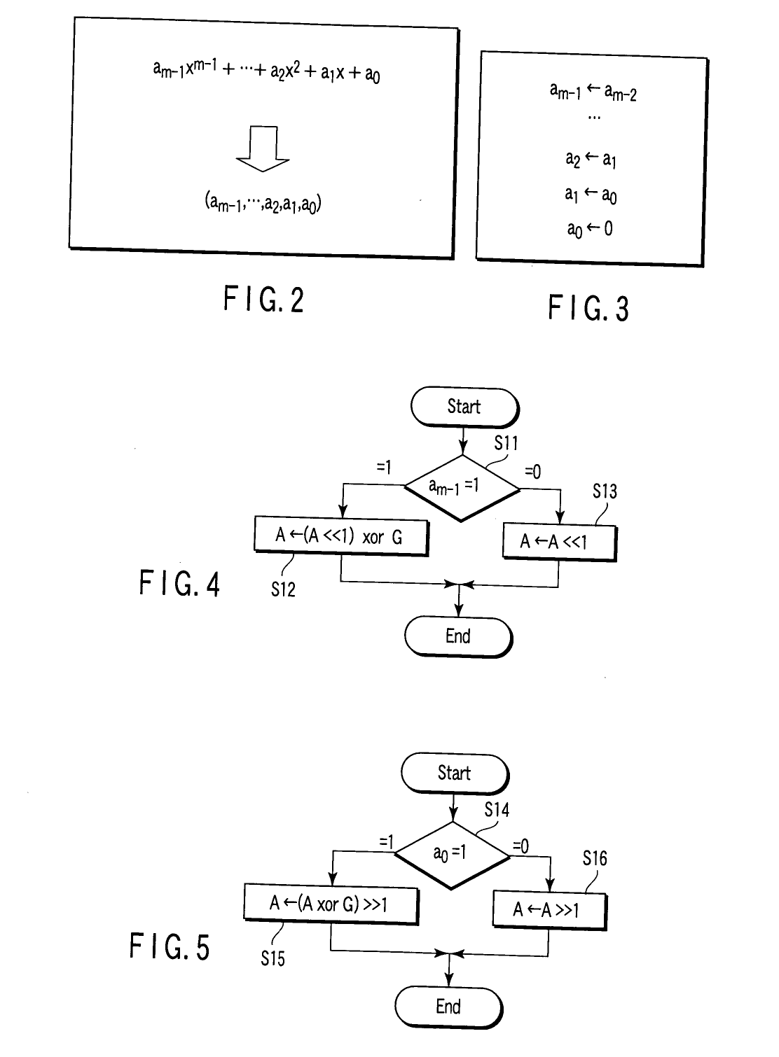

Any (m−1) th-order polynomial will hereinafter be expressed by arranging only coefficients, as shown in FIG. 2. For example, modulo (x⁴+x+1) is expressed in the form of (1, 0, 0, 1, 1), and (x+1) in the form of (0, 0, 0, 1, 1). Similarly, (x³+x²+x) is expressed in the form of (0, 1, 1, 1, 0), 0 in the form of (0, 0, 0, 0, 0), and 1 in the form of (0, 0, 0, 0, 1).

In accordance with this type of expression, left_shift (A) is expressed as shown in FIG. 3.

Further, double (A) is expressed as shown in FIG. 4. A<<1 at steps S12 and S13 represents left-shift of A by one bit.

Similarly, half (A) is expressed as shown in FIG. 5. A>>1 at steps S15 and S16 represents right-shift of A by one bit.

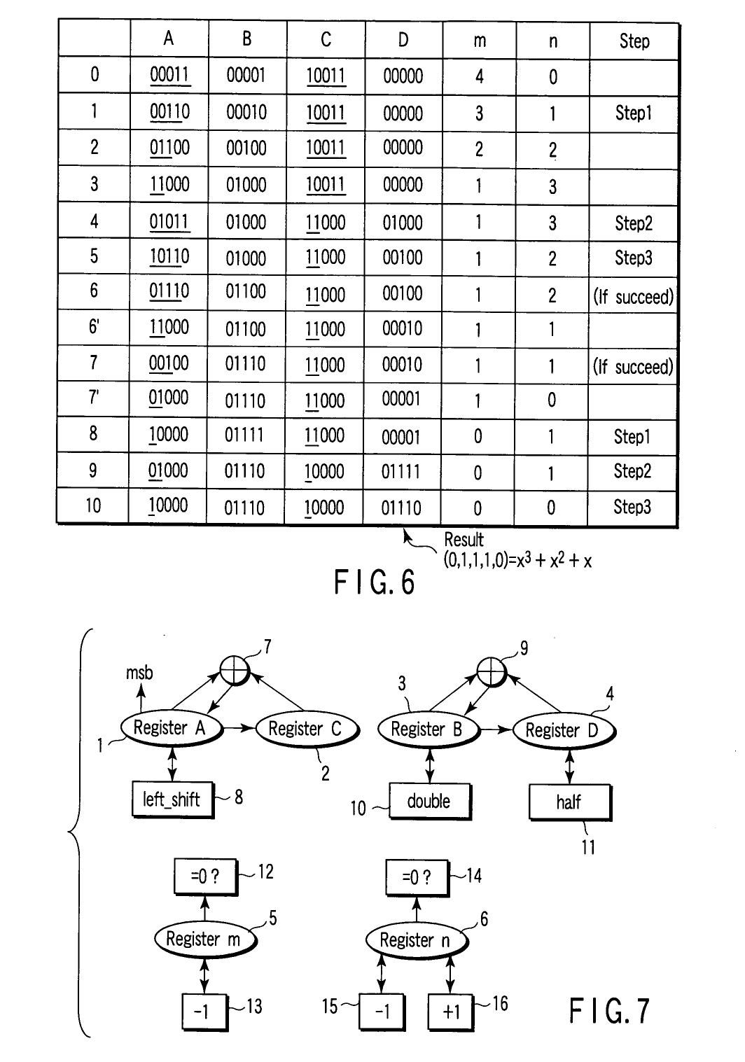

FIG. 6 shows the mid-calculation results of the above algorithm executed to obtain the inverse of a in a case where modulo G=x⁴+x+1 and a=x+1, i.e., (x+1)⁻¹ mod (x⁴+x+1) (in this case, b=1).

Since modulo G=x⁴+x+1, m=4. Accordingly, C=10011. Further, since divisor a=x+1 and m=4, the initial value of A is set to 00011. Since dividend b=1 and m=4, the initial value of B is set to 00001. Furthermore, the initial value of D is 00000, and that of n is 0.

In this example, since the final value of D is 01110, the resultant inverse element is x³+x²+x.

FIG. 7 shows hardware for executing the above algorithm.

The hardware that executes the algorithm comprises six registers—a first register A (denoted by reference numeral 1 in FIG. 7), second register C (denoted by reference numeral 2), third register B (denoted by reference numeral 3), fourth register D (denoted by reference numeral 4), fifth register m (denoted by reference numeral 5) and sixth register n (denoted by reference numeral 6). The hardware further comprises circuits denoted by reference numerals 7-16, and a control circuit (not shown) for controlling the registers and circuits.

The register A is connected to a left-shift circuit 8 and exclusive-OR circuit 7 that is also connected to the register C. The register A outputs the most significant bit (msb) to the control circuit. The register A stores a divisor as an initial value.

The register C is connected to the register A for inputting data therefrom, and to the exclusive-OR circuit 7 for outputting data thereto. The register C stores a modulo as an initial value and holds a content of the register A on a first condition.

The register B is connected to a doubling computing circuit (double) 10 in the extension field with characteristic 2, and to an exclusive-OR circuit 9 that is also connected to the register D. The register B stores a dividend as an initial value.

The register D is connected to the register B, also to a halving computing circuit (half) 11 in the extension field with characteristic 2, and to the exclusive-OR circuit 9. The register D stores zero value as an initial value and holds a content of the third register on the first condition.

The register m is connected to a decrement circuit 13 and determination circuit 12 for determining whether or not the data output from the register is 0. The register m stores a number of bits of the modulo as an initial value.

The register n is connected to an increment circuit 16, decrement circuit 15 and determination circuit 14 for determining whether or not the data output from the register is 0. The register n stores zero value as an initial value.

The registers A-D can store several hundred bits, and the registers m and n are of bits that enable several hundred values to be stored. If the registers A-D have an approximately 200-bit length, it is sufficient if the registers m and n have an 8-bit length.

The order of the critical paths of the above-described structure is determined by the increment and decrement circuits of the registers m and n, and is O (log log m).

The above-described structure executes the polynomial inverse computing algorithm. Specifically, after parameters are input and variables are initialized, the following steps are performed. Unless the most significant bit of the register A is 1, an initial state (step 1) is assumed in which the content of the register A is left-shifted, the content of the register B is doubled in the extension field with characteristic 2, the content of the register m is decremented by 1, and the content of the register n is incremented by 1. These operations are repeated. If the most significant bit of the register A is 1, a second state (step 2) is assumed.

In the second state (step 2), the register A stores the exclusive OR of the contents of the registers A and C, and the register C stores the content of the register A. Further, the register B stores the exclusive OR of the contents of the registers B and D, and the register D stores the content of the register B. After that, the state is shifted to a third state (step 3).

In the third state (step 3), if the content of the register n is not 0 and the most significant bit of the register A is 1, the exclusive-OR result of the contents of the registers A and C is stored in the register A, while the exclusive-OR result of the contents of the registers B and D is added to that of the register B. On the other hand, if the content of the register n is not 0 and the most significant bit of the register A is 0, nothing is done. After that, the content of the register n is decremented by 1, the content of the register A is left-shifted, and the content of the register D is multiplied by ½ in the extension field with characteristic 2. These operations are repeated. If the content of the register n becomes 0 and the content of the register m is not 0, the state is shifted to the initial state (step 1), whereas if the content of the register m is 0, the content of the register D is output as the result of the algorithm.

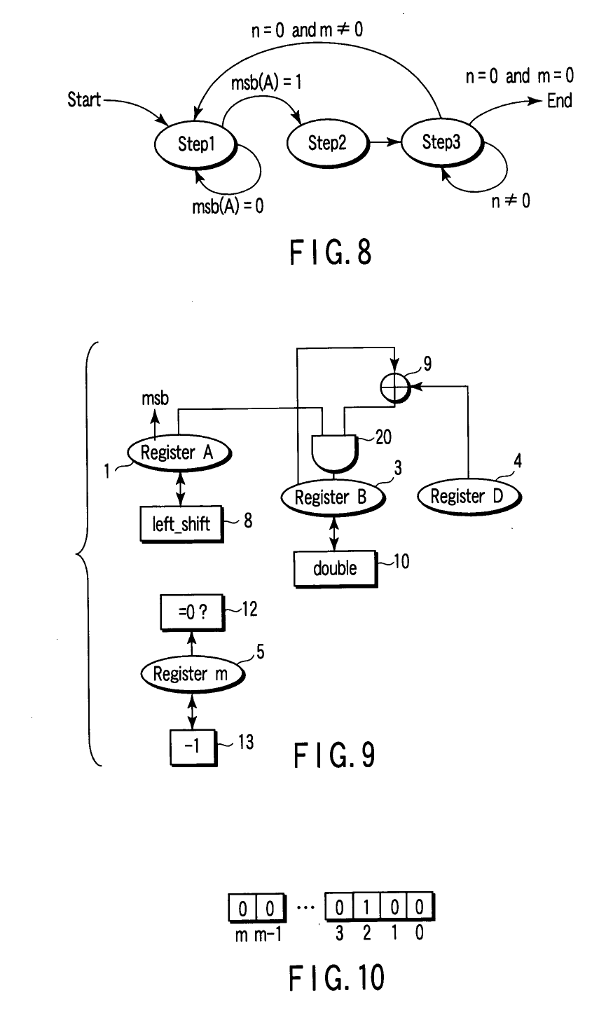

FIG. 8 shows a state transition diagram assumed by hardware for executing the above algorithm.

The initial state is the step 1 and is kept in the step 1 as long as msb (A) is 0.

If msb (A) becomes 1, the state is shifted to the step 2, and the step 2 is shifted to a step 3 unconditionally after the processing of the step 2 is finished.

Unless n is 0, the step 3 is maintained. On the other hand, if n becomes 0, the state is returned to the step 1 unless m is 0, whereas if m is 0, the processing finishes.

As described above, the embodiment can reduce the circuit scale and delay, compared to the conventional case, when a VLSI is employed which is dedicated to an algorithm for computing the inverse of each element in the Galois field with characteristic 2.

For example, assuming that the highest-order of a modulo polynomial is m the circuit depth of the conventional method is log m. On the other hand, the embodiment can reduce the circuit depth to log log m.

Further, the embodiment can provide the advantage that all shifting operations are 1-bit fixed shifting.

FIG. 9 shows a combination of the structure of FIG. 7 and that of a multiplier that can use most of the components of a VLSI. In the case of FIG. 9, the multiplier and polynomial inverse computing apparatus can commonly use four registers, left_shift circuit, exclusive OR circuit, doubling computing circuit, determination circuit and decrement circuit. More specifically, the multiplier of FIG. 9 and the polynomial inverse computing apparatus of FIG. 7 can commonly use the register A, left_shift circuit 8, register B, register D, exclusive OR circuit 9, doubling computing circuit 10, register m, determination circuit 12 and decrement circuit 13. It is only an AND circuit 20 that the multiplier additionally requires.

A multiplication algorithm for computing B←A×D will now be described.

A, D, G and m (G represents an mth-order polynomial, and A and D represent polynomials whose order is lower than m) are inputs.

```
  <Multiplication algorithm>
  Input of parameter values
B = 0
  while m ≠ 0
  m ← m−1
  B ← double (B)
  A ← left_shift(A)
  if msb(A) = 1 then B ← B xor D
  wend
B is output
  <Multiplication algorithm>
```

If the registers m and n are formed of one-hot counters, a polynomial inverse computing circuit can be realized in which the entire circuit delay corresponds to a predetermined number of stages, regardless of the number of bits of each input.

FIG. 10 shows an example of a one-hot counter.

The one-hot counter comprises (m+1) registers, and expresses a number, using the number assigned to the counter that stores data “1” (“1” is stored in only one of the registers). In the case of FIG. 10, since “1” is stored in a register with number 2, the one-hot counter expresses number 2.

The one-hot counter is characterized in the following three points:

i) The operation of increasing, by 1, the number to be expressed is left-shifting;

ii) The operation of decreasing, by 1, the number to be expressed is right-shifting; and

iii) To determine whether the expressed number is identical to a particular number, it is sufficient if it is determined whether a particular bit corresponding to the particular number is “1”.

The circuit delay in each of the above operations corresponds to a predetermined number of stages.

The above-described polynomial inverse computing algorithm 1 and FIG. 1 illustrating this algorithm can be modified in various ways.

A description will be given of the case where the algorithm 1 is modified to use a single processing loop, so that it can be more easily utilized in hardware.

This modified polynomial inverse computing algorithm will be specified.

```
<Polynomial inverse computing algorithm 2>
A, B, G and m (G represents an mth-order polynomial,
and A and B represent polynomials whose order is lower
than m) are inputs
  C ← G
  D ← 0
  n ← 0
  state ← 1
  while m≠0 and n≠0
    f ← msb(A)
    if f = 1 then
      if state = 1 then
        (A, C) ← (A xor C, A)
        (B, D) ← (B xor D, B)
      else
        A ← A xor C
        B ← B xor D
      endif
    endif
    A ← left_shift(A)
    if state = 1 and (f = 0 or n = 0) then
      m ← m−1
      n ← n+1
      B ← double (B)
    else
      n ← n−1
      D ← half(D)
      if n = 0 then state ← 1 else state ← 0
    endif
wend
D is output.
<Polynomial inverse computing algorithm 2>
```

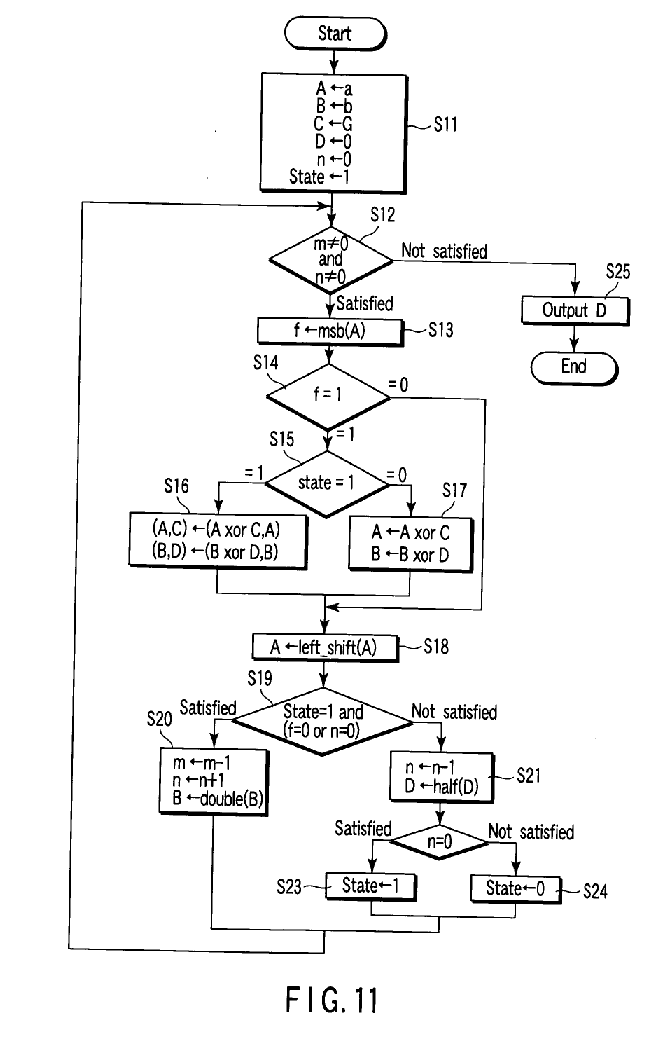

The contents of the algorithm 2 are expressed in the form of a flowchart in FIG. 11.

Compared to the previously-described polynomial inverse computing algorithm 1, 1-bit variables such as “state” and “f” are added in the algorithm 2. Variable “f” is used to hold msb (A) since A is changed during processing (however, “f” is not needed if hardware for realizing its function is employed). The variable “state” indicates which one of the two loops of the polynomial inverse computing algorithm 1 is currently being executed (since the variable “state” stores the current state, a storage is needed if the variable is realized by hardware). “f=0” indicates that the program is in the initial loop (step 1) or step 2, and “f=1” indicates that the program is in the latter loop (step 3).

If the polynomial inverse computing algorithm 2 is executed by dedicated hardware, this hardware has the same configuration as that of FIG. 7.

Also in this case, the multiplier as shown in FIG. 9 and utilizing the multiplier algorithm can be constructed by adding the AND circuit 20 to the configuration of FIG. 7.

The mid-calculation result of each register that is executing the polynomial inverse computing algorithm is basically the same as that shown in FIG. 6.

Furthermore, the embodiment of the invention can be modified in various ways so that any algorithm equivalent to the polynomial inverse computing algorithm 1 or 2 can be executed. Such modifications can also provide the same advantage as the above-described one.

The above-described functions can be also realized by software.

Yet further, the embodiment of the invention can be realized as a program for enabling a computer to execute predetermined means or function (or for making a computer function as predetermined means), and can be also realized as a recording medium that can be read by a computer with the program.

In the embodiment of the invention, if the polynomial inverse computing algorithm for use in the Galois field with characteristic 2 is realized by a dedicated VLSI, the circuit scale and delay can be more suppressed than in the prior art. For example, if the highest order of a polynomial as a modulo is m, the circuit depth in the prior art is log m, whereas the embodiment of the present invention can be reduced to log log m.

Further, the embodiment of the invention is advantageous in that all shift operations can be executed by one-bit-fixed shift.

In the embodiment of the invention, most components can be commonly used by the polynomial inverse computing apparatus and multiplier.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A polynomial inverse computing apparatus comprising:
a plurality of registers including a first register, a second register, a third register, a fourth register, a fifth register, and a sixth register;
a left shift unit;
a first exclusive-OR unit and a second exclusive-OR unit;
a doubling computing unit configured to execute doubling computation in an extension field with characteristic 2;
a halving computing unit configured to execute halving computation in the extension field of characteristic 2;
a determination unit configured to determine whether or not a content of each of the registers is a zero value;
a decrement unit configured to decrement the content of each of the registers; and
an increment unit configured to increment the content of each of the registers.

2. The polynomial inverse computing apparatus according to claim 1, further comprising a controller which controls the left shit unit, the doubling computing unit, the first decrement unit, the second decrement unit, the increment unit, the first register, the second register, the third register, the fourth register, the first exclusive-OR unit, the second exclusive-OR unit, the determination unit, and the halving computing unit in a first state that a most significant bit of the first register fails to be 1, a second state that the most significant bit of the first register is 1, and a third state after the second state finishes,
in the first state, a first series of operations are repeatedly performed,
the first series of operations including left-shift of a content of the first register by the left shift unit, doubling of a content of the third register by the doubling computing unit, decrement of a content of the fifth register by 1 by the first decrement unit, and increment of a content of the sixth register by 1 by the increment unit,
in the second state shifted from the first state if the most significant bit of the first register is 1, the first register and the second register store an output of the first exclusive-OR unit and the content of the first register, respectively, and the third register and the fourth register store an output of the second exclusive-OR unit and the content of the third register, respectively,
in the third state shifted from the second state after the second state finishes, unless the determination unit determines that the content of the sixth register is a zero value, and as long as the most significant bit of the first register is 1, a second series of operations are repeatedly performed,
the second series of operations including storage of the output of the first exclusive-OR unit into the first register, storage of the output of the second exclusive-OR unit into the third register, decrement of the content of the sixth register by 1 by the second decrement unit, left-shift of the content of the first register by the left-shift unit, and halving of a content of the fourth register by the halving computing unit,
the third state being shifted to the first state if the determination unit determines that the content of the sixth register is the zero value and if the determination unit determines that the content of the fifth register is a non-zero value,
the content of the fourth register being output as a result if the second determination unit determines that the content of the sixth register is the zero value and if the first determination unit determines that the content of the fifth register is the zero value.

3. The polynomial inverse computing apparatus according to claim 1, wherein:
if the most significant bit of the first register is 1,
(a) the second register holds a content of the first register,
(b) the fourth register holds a content of the third register,
(c) the first exclusive-OR unit obtains a first exclusive-OR result of contents of the first register and the second register and outputs the first exclusive-OR result to the first register, and
(d) the second exclusive-OR unit obtains a second exclusive-OR result of contents of the third register and fourth register and outputs the second exclusive-OR result to the third register;
if the most significant bit of the first register is the zero value,
the left shift unit left-shifts the content of the first register,
the doubling computing unit executes doubling computation on the content of the third register in an extension field with characteristic 2,
the first decrement unit decrements a content of the fifth register, and
the second decrement unit decrements a content of the sixth register;
if the above-mentioned operations (a), (b), (c) and (d) are executed and if the content of the sixth register is a non-zero value and if a most significant bit of the first register is 1, and then if the above-mentioned operations (c) and (d) are executed, the halving computing unit executes halving computation on a content of the fourth register in the extension field with characteristic 2, and the increment unit increments the content of the sixth register, if the above-mentioned operations (a), (b), (c) and (d) are executed and if the content of the sixth register is the zero value, the first determination unit determines whether or not the content of the fifth register is the zero value; and
if the above-mentioned operations (a), (b), (c) and (d) are executed, the second determination unit determines whether or not the content of the sixth register is the zero value.

4. A polynomial inverse computing apparatus comprising:
a first register which stores a divisor as an initial value;
a second register which stores a modulo as an initial value and holds a content of the first register in a first condition;
a third register which stores a dividend as an initial value;
a fourth register which stores a zero value as an initial value and holds a content of the third register in the first condition;
a fifth register which stores a number of bits of the modulo as an initial value;
a sixth register which stores the zero value as an initial value;
a first exclusive-OR unit configured to obtain a first exclusive-OR result of contents of the first register and the second register and outputs the first exclusive-OR result to the first register in the first condition;
a second exclusive-OR unit configured to obtain a second exclusive-OR result of contents of the third register and the fourth register and outputs the second exclusive-OR result to the third register in the first condition;
a left shift unit configured to left-shift the content of the first register in a second condition;
a doubling computing unit configured to execute doubling computation on the content of the third register in an extension field with characteristic 2 in the second condition;
a first decrement unit configured to decrement a content of the fifth register in the second condition;
a second decrement unit configured to decrement a content of the sixth register in the second condition;
a halving computing unit configured to executes halving computation on a content of the fourth register in the extension field with characteristic 2 in a third condition;
an increment unit configured to increment the content of the sixth register in the third condition;
a first determination unit configured to determine, in a fourth condition, whether or not the content of the fifth register is the zero value; and
a second determination unit configured to determine, in a fifth condition, whether or not the content of the sixth register is the zero value.

5. The polynomial inverse computing apparatus according to claim 4, wherein:
if a most significant bit of the first register is 1,
the second register holds the content of the first register,
the fourth register holds the content of the third register,
the first exclusive-OR unit obtains the first exclusive-OR result and outputs the first exclusive-OR result to the first register, and
the second exclusive-OR unit obtains the second exclusive-OR result and outputs the second exclusive-OR result to the third register.

6. The polynomial inverse computing apparatus according to claim 4, wherein:
if the most significant bit of the first register is the zero value,
the left shift unit left-shifts the content of the first register,
the doubling computing unit executes doubling computation on the content of the third register in an extension field with characteristic 2,
the first decrement unit decrements the content of the fifth register, and
the second decrement unit decrements the content of the sixth register.

7. The polynomial inverse computing apparatus according to claim 4, wherein:
if the following operations. (a), (b), (c) and (d) are executed and if the content of the sixth register is a non-zero value and if a most significant bit of the first register is 1, and then if the following operations (c) and (d) are executed,
(a) the second register holds a content of the first register,
(b) the fourth register holds a content of the third register,
(c) the first exclusive-OR unit obtains a first exclusive-OR result of contents of the first register and the second register and outputs the first exclusive-OR result to the first register, and
(d) the second exclusive-OR unit obtains a second exclusive-OR result of contents of the third register and fourth register and outputs the second exclusive-OR result to the third register,
the halving computing unit executes halving computation on a content of the fourth register in the extension field with characteristic 2, and the increment unit increments the content of the sixth register.

8. The polynomial inverse computing apparatus according to claim 4, wherein:
if the following operations (a), (b), (c) and (d) are executed and if the content of the sixth register is a non-zero value,
(a) the second register holds a content of the first register,
(b) the fourth register holds a content of the third register,
(c) the first exclusive-OR unit obtains a first exclusive-OR result of contents of the first register and the second register and outputs the first exclusive-OR result to the first register, and
(d) the second exclusive-OR unit obtains a second exclusive-OR result of contents of the third register and fourth register and outputs the second exclusive-OR result to the third register,
the first determination unit determines whether or not the content of the fifth register is the zero value.

9. The polynomial inverse computing apparatus according to claim 4, wherein:
if the following operations (a), (b), (c) and (d) are executed and if the content of the sixth register is a non-zero value,
(a) the second register holds a content of the first register,
(b) the fourth register holds a content of the third register,
(c) the first exclusive-OR unit obtains a first exclusive-OR result of contents of the first register and the second register and outputs the first exclusive-OR result to the first register, and
(d) the second exclusive-OR unit obtains a second exclusive-OR result of contents of the third register and fourth register and outputs the second exclusive-OR result to the third register,
the second determination unit determines whether or not the content of the sixth register is the zero value.
the second determination unit determines whether or not the content of the sixth register is the zero value.

10. The polynomial inverse computing apparatus according to claim 4, wherein:
in a first state, unless a most significant bit of the first register is 1, a first series of operations are repeatedly performed,
the first series of operations including left-shift of the content of the first register by the left shift unit, doubling of the content of the third register by the doubling computing unit, decrement of the content of the fifth register by 1 by the first decrement unit, and increment of the content of the sixth register by 1 by the increment unit,
in a second state shifted from the first state if the most significant bit of the first register is 1, the first register and the second register store an output of the first exclusive-OR unit and the content of the first register, respectively, and the third register and the fourth register store an output of the second exclusive-OR unit and the content of the third register, respectively,
in a third state shifted from the second state after the second state finishes, unless the second determination unit determines that the content of the sixth register is the zero value, and as long as the most significant bit of the first register is 1, a second series of operations are repeatedly performed,
the second series of operations including storage of the output of the first exclusive-OR unit into the first register, storage of the output of the second exclusive-OR unit into the third register, decrement of the content of the sixth register by 1 by the second decrement unit, left-shift of the content of the first register by the left-shift unit, and halving of the content of the fourth register by the halving computing unit,
the third state being shifted to the first state if the second determination unit determines that the content of the sixth register is the zero value and if the first determination unit determines that the content of the fifth register is a non-zero value,
the content of the fourth register being output as a result if the second determination unit determines that the content of the sixth register is the zero value and if the first determination unit determines that the content of the fifth register is the zero value.

11. The polynomial inverse computing apparatus according to claim 4, wherein if a most significant bit of the third register is 1, the doubling computing unit left-shifts the content of the third register by one bit and obtains an exclusive-OR result of the content of the third register and the modulo, and
if the most significant bit of the third register is the zero value, the doubling computing unit left-shifts the content of the third register by one bit.

12. The polynomial inverse computing apparatus according to claim 4, wherein if a least significant bit of the fourth register is 1, the halving computing unit obtains an exclusive-OR result of the content of the fourth register and the modulo, and right-shifts the content of the fourth register by one bit, and
if the least significant bit of the fourth register is zero value, the halving computing unit right-shifts the content of the fourth register by one bit.

13. The polynomial inverse computing apparatus according to claim 4, wherein the fifth register is formed of a one-hot counter.

14. The polynomial inverse computing apparatus according to claim 4, wherein the sixth register is formed of a one-hot counter.

15. A multiplier apparatus comprising:
a plurality of registers including a first register, a second register, a third register, and a fourth register,
the first register, the second register, the third register, and the fourth register store a multiplier, a zero value, a multiplicand, and a modulo, respectively, the registers being used for a polynomial inverse computing apparatus;
a determination unit configured to determine whether or not a content of the fourth register is the zero value;
if the determination unit determines the content of the fourth register is a non-zero value,
a decrement unit configured to decrement the content of the fourth register;
a doubling computing unit configured to execute doubling computation in an extension field with characteristic 2 to the second register;
a left shift unit configured to left-shift the content of the first register;
if a most significant bit of the first register is 1,
a exclusive-OR unit configured to obtain a exclusive-OR result of contents of the second register and the third register and output the exclusive-OR result to the second register; and
an output unit configured to output a content of the second register if the determination unit determines the content of the fourth register is the zero value.

16. The multiplier apparatus according to claim 15, wherein: if the first register, the second register, the third register, and the fourth register are used for a polynomial inverse computing apparatus,
the first register stores a divisor as an initial value,
the second register stores a dividend as an initial value,
the third register stores zero value as an initial value and holds a content of the second register, and
the fourth register stores a number of bits of the modulo as an initial value.

17. A polynomial inverse computing method comprising:
storing, as initial values into a first register, a second register, a third register, a fourth register, a fifth register, and a sixth register, a divisor, a modulo, a dividend, a zero value, a number of bits of the modulo and the zero value, respectively;
in a first state, unless a most significant bit of the first register is 1, repeatedly performing a first series of operations, the first series of operations including
left-shifting a content of the first register,
doubling a content of the third register,
decrementing a content of the fifth register by 1, and
incrementing a content of the sixth register by 1,
the first state being;
in a second state shifted from the first state if the most significant bit of the first register is 1,
storing an output of a first exclusive-OR unit which inputs contents of the first register and the second register, and the content of the first register into the first register and the second register, respectively, and
storing a second exclusive-OR unit which inputs contents of the third register and the fourth register, and the content of the third register into the third register and the fourth register, respectively,
in a third state shifted from the second state after the second state finishes, unless the content of the sixth register is the zero value, and as long as the most significant bit of the first register is 1, repeatedly performing a second series of operations, the second series of operations including
storing the output of the first exclusive-OR unit into the first register,
storing the output of the second exclusive-OR unit into the third register,
decrementing the content of the sixth register by 1, left-shifting the content of the first register, and
halving the content of the fourth register,
the third state being shifted to the first state if the content of the sixth register is the zero value and if the content of the fifth register is non-zero value,
the content of the fourth register being output as a result if the content of the sixth register is the zero value and if the content of the fifth register is the zero value.

18. The polynomial inverse computing method according to claim 17, wherein in the doubling, if the most significant bit is 1, the content of the third register is left-shifted by one bit, and an exclusive-OR result of the content of the third register and the modulo is obtained, and
if the most significant bit of the third register is the zero value, the content of the third register is left-shifted by one bit.

19. The polynomial inverse computing method according to claim 17, wherein in the halving, if a least significant bit of the fourth register is 1, an exclusive-OR result of the content of the fourth register and the modulo is obtained, and the content of the fourth register is right-shifted by one bit, and
if the least significant bit of the fourth register is the zero value, the content of the fourth register is right-shifted by one bit.
